(19) United States
(12) Patent Application Publication
(10) Pub. No.: US 2025/0234278 A1
(43) Pub. Date: Jul. 17, 2025

(54) TUNNELED QUERY FOR DISCOVERING NEIGHBORING ACCESS POINTS

(71) Applicant: Cisco Technology, Inc., San Jose, CA (US)

(72) Inventors: Binita Gupta, San Diego, CA (US); Brian Donald Hart, Sunnyvale, CA (US); Malcolm Muir Smith, Richardson, TX (US)

(21) Appl. No.: 19/017,133

(22) Filed: Jan. 10, 2025

Related U.S. Application Data
(60) Provisional application No. 63/719,046, filed on Nov. 11, 2024.
(60) Provisional application No. 63/620,877, filed on Jan. 15, 2024.

(51) Int. Cl. H04W 48/16; H04W 84/12

(52) U.S. Cl. CPC H04W 48/16; H04W 84/12

(57) ABSTRACT

A system and method are disclosed for discovering neighboring candidate access points. A neighbor-probe request is sent from a station to a serving AP (access point) requesting probe-response information. The neighbor-probe request is a management frame that includes a multi-link element indicating what information is included in the probe-response information that is requested for one or more neighboring APs of the serving AP. The serving AP collects the probe-response information in accordance with the multi-link element and using backhaul communications that do not interfere with wireless communications between the station and the serving AP. The serving AP sends to the station a neighbor-probe response that includes the probe-response information. Before sending the probe-response information, the serving AP can filter the probe-response information, e.g., based on BPCC information received from the station or based on the neighboring APs being on a same floor as the station or serving AP.

### CROSS-REFERENCE TO RELATED APPLICATIONS

This application claims priority to and the benefit of U.S. Prov. App. No. 63/719,046, filed on Nov. 11, 2024, and U.S. Prov. App. No. 63/620,877, filed on Jan. 15, 2024, which are expressly incorporated herein by reference in their entirety.

### TECHNICAL FIELD

The present technology pertains to wireless communication network, and more specifically, to improving seamless roaming by using a tunneled query for discovering neighboring access points.

### BACKGROUND

Wi-Fi technology has undergone continuous evolution and innovation since its inception, resulting in significant advancements with each new generation. Following Wi-Fi 5 (802.11ac) there has been Wi-Fi 6 (802.11ax), Wi-Fi 7 (802.11be), and soon there will be Wi-Fi 8 (802.11bn) and Wi-Fi 9, each new Wi-Fi generation brings notable improvements in speed, capacity, efficiency, and overall performance.

Wi-Fi 5 introduced substantial upgrades over its predecessor, Wi-Fi 4 (802.11n). It introduced the use of wider channel bandwidths, multi-user MIMO (Multiple-Input Multiple-Output), and beamforming technologies. These advancements significantly increased data transfer rates and improved network capacity, allowing multiple devices to simultaneously connect and communicate more efficiently. Wi-Fi 6 includes enhanced orthogonal frequency-division multiple access (OFDMA) and target wake time (TWT) mechanisms. Wi-Fi 6 also includes improved overall spectral efficiency, power management, and better performance in crowded areas. Wi-Fi 7 (802.11be) delivers speeds of up to 30 Gbps, utilizing multi-band operation, advanced MIMO techniques, and improved modulation schemes. Wi-Fi 7 also focuses on reducing latency and enhancing security features.

Wi-Fi 8 (802.11bn) aims to revolutionize wireless connectivity by providing ultra-high reliability enabling rich experiences for QoS demanding applications such as cloud gaming, AR/VR, industrial IoT, wireless TSN etc. Wi-Fi 8 is expected to introduce advancements like seamless roaming, multi-AP coordination for predictable QoS, enhanced power saving and advanced beamforming techniques paving the way for futuristic applications and seamless connectivity experiences.

As Wi-Fi technology continues to evolve, each new generation brings improvements that address the growing demands of modern networks, including increased device density, higher data rates, lower latency, improved reliability, and better overall network performance. These advancements play a crucial role in enabling emerging technologies, supporting the proliferation of smart devices, and transforming the manner in which devices connect and communicate in an increasingly interconnected world.

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a block diagram of an example wireless communication network in accordance with some embodiments.

FIG. 2A illustrates an example of a single floor of building equipped with wireless communication in accordance with some embodiments.

FIG. 2B illustrates an illustrative schematic diagram for MLO between an AP MLD with affiliated logical entities and a Non-AP MLD with affiliated logical entities in accordance with some embodiments.

FIG. 3 illustrates a seamless mobility domain in accordance with some embodiments.

FIG. 4A illustrates an example of a probe-request frame in accordance with some embodiments.

FIG. 4B illustrates an example of a multi-link element in accordance with some embodiments.

FIG. 5 illustrates an example of a signaling exchange between a STA and a serving AP MLD for providing a neighbor-probe response in accordance with some embodiments.

FIG. 6 illustrates a flow diagram of a method for discovering neighboring candidate access points in accordance with some embodiments.

FIG. 7 shows an example of an example of computing system in accordance with some embodiments.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

### OVERVIEW

### Abbreviations

Extremely high throughput (EHT)
Station (STA)
Media Access Control (MAC)
Access Point (AP)
Wireless LAN Controller (WLC)
Wi-Fi Protected Access (WPA)
Multi-Link Device (MLD)
Multi-link operation (MLO)
Extended Service Set (ESS)
Basic Service Set (BSS)
BSS Parameters Change Count (BPCC)
Basic Service Set Identifier (BSSID)
Service Set Identifier (SSID)
Wireless Local Area Network (WLAN)
Reduced Neighbor Report (RNR)
Make-Before-Break Roaming (MBBR)

The proposed technology is directed to a method for a client device to discover neighboring Access Points (APs) in a wireless network environment.

In some aspects, the techniques described herein relate to a method for discovering neighboring candidate access points, the method including: receiving, at a serving AP (access point), a neighbor-probe request from a station requesting probe-response information, wherein the neighbor-probe request is a management frame that includes one or more multi-link elements indicating what information is to be included in the probe-response information that is requested for one or more neighboring APs of the serving AP; collecting, at the serving AP, the probe-response information for the one or more neighboring APs of the serving AP, wherein the serving AP collects the probe-response information in accordance with the one or more multi-link elements; and sending, from the serving AP to the station, a neighbor-probe response that includes the probe-response information.

In some aspects, the techniques described herein relate to a method, wherein: the station is a non-AP multi-link device (MLD), the serving AP is an AP MLD, and the one or more neighboring APs includes at least one AP MLD that is a neighboring AP MLD of the serving AP MLD.

In some aspects, the techniques described herein relate to a method, wherein the neighbor-probe request is an extension of a neighbor-report request of an IEEE 802.11k standard.

In some aspects, the techniques described herein relate to a method, wherein: at least one of the one or more neighboring APs is an AP multi-link device (MLD), the neighbor-probe request includes the one or more multi-link elements, the one or more multi-link elements includes one or more identifiers for one or more target AP MLDs for which the probe-response information is requested, and each multi-link element of the one or more multi-link elements is a neighbor probe request multi-link element.

In some aspects, the techniques described herein relate to a method, wherein: the neighbor probe request multi-link element is a multi-link element with a new type, or a probe request multi-link element, the one or more identifiers are MLD media access control (MAC) Address, AP MLD identifiers (IDs), or another identifier for a target AP MLD, and the neighbor probe request is a probe request frame or another management frame and the neighbor probe response is a probe response frame or another management frame.

In some aspects, the techniques described herein relate to a method, wherein the one or more identifiers are MLD media access control (MAC) Address, AP MLD identifiers (IDs) that are obtained from a reduced neighbor report (RNR), or another identifier for a target AP MLD.

In some aspects, the techniques described herein relate to a method, wherein the one or more identifiers are included as part of a common information field in the multi-link element.

In some aspects, the techniques described herein relate to a method, wherein: the multi-link element includes at least one first sub-element indicating link IDs of a subset of affiliated APs of a target AP MLD, and the link IDs in the at least one first sub-element indicates that the probe-response information is requested for the affiliated APs indicated by the Link IDs, and the at least one first sub-element is one or more Per-STA Profile sub-elements.

In some aspects, the techniques described herein relate to a method, wherein: each of the one or more multi-link elements includes one or more sub-elements indicating link IDs of a subset of affiliated APs of a target AP MLD, and the link IDs in the one or more sub-elements indicate that the probe-response information is requested for the affiliated APs indicated by the Link IDs, the one or more sub-elements are one or more Per-STA Profile sub-elements, and an absence of the one or more sub-elements indicates that the probe-response information is requested for all affiliated APs of the target AP MLD.

In some aspects, the techniques described herein relate to a method, wherein: each sub-element in the one or more sub-elements includes a station control field indicating a value of a last known basic service set (BSS) parameters change count (BPCC) for respective affiliated AP of the target AP MLD indicated by the link ID, the station control field includes a complete profile subfield that signals whether a complete profile or a partial profile is requested for an affiliated AP of the target AP MLD, and when a value of the complete profile subfield signals that the partial profile of the affiliated AP is requested, values of a station profile field include one or more request elements and/or one or more extended request element that indicate specific elements for which affiliated AP information is requested for the affiliated AP, and an absence of the one or more request elements and/or an absence of the one or more extended request elements signals which elements are returned for the one or more neighboring APs are determined by other elements included in the neighbor-probe request.

In some aspects, the techniques described herein relate to a method, wherein the at least one first sub-element includes a station control field indicating values of a last known basic service set (BSS) parameters change count (BPCC) for respective affiliated APs of the target AP MLD.

In some aspects, the techniques described herein relate to a method, wherein the station control field includes a complete profile subfield that signals whether a complete profile or a partial profile is requested an affiliated AP of the target AP MLD (e.g., as defined in IEEE 802.11be draft).

In some aspects, the techniques described herein relate to a method, wherein, when a value of the complete profile subfield signals that the partial profile of the affiliated AP is requested (e.g., by setting Complete Profile=0), values of a station profile field include one or more request elements and/or one or more extended request element that indicate specific elements for which affiliated AP information is requested for the affiliated AP.

In some aspects, the techniques described herein relate to a method, wherein, an absence of the one or more request elements and/or an absence of the one or more extended request elements signals which elements are returned for the one or more neighboring APs are determined by other elements included in the neighbor-probe request.

In some aspects, the techniques described herein relate to a method, wherein the neighbor-probe request includes a basic service set identifier (BSSID) element indicating a list of BSSIDs (basic service set identifiers) of one or more neighboring APs for which probe-response information is requested.

In some aspects, the techniques described herein relate to a method, wherein the multi-link element indicates the one or more BSSIDs using an element that includes a list of BSSIDs.

In some aspects, the techniques described herein relate to a method, wherein the multi-link element includes an identifier indicating that the probe-response information is requested for neighboring APs within N-hops of the serving AP, without specifying which of the neighboring APs within N hops of the probe-response information is requested for.

In some aspects, the techniques described herein relate to a method, wherein the multi-link element includes an identifier indicating one or more criteria based on which of the one or more neighboring APs the probe-response information is requested.

In some aspects, the techniques described herein relate to a method, wherein the multi-link element of the neighbor-probe request is further configured to provide indicia selecting one or more neighboring AP MLDs for which the probe-response information is requested.

In some aspects, the techniques described herein relate to a method, wherein the multi-link element is further configured to provide indicia of a subset of affiliated APs of the selected one or more neighboring AP MLDs, wherein the subset of affiliated APs are indicated by respective link identifiers (IDs).

In some aspects, the techniques described herein relate to a method, wherein the neighbor-probe request includes a station control field indicating values of a last known BPCC (basic service set parameters change count) for the affiliated APs.

In some aspects, the techniques described herein relate to a method, wherein: the neighbor-probe request includes an SSID (service set identifier) element that indicates one or more SSIDs of one or more neighboring APs or AP MLDs for which the probe-response information is requested, and an absence of SSID information in the SSID element signals the receiving AP to use all SSIDs for providing probe responses for the one or more neighboring APs or AP MLDs.

In some aspects, the techniques described herein relate to a method, wherein an absence of SSID information in the SSID element signals the receiving AP to use all SSIDs for providing probe responses for the one or more neighboring AP MLDs.

In some aspects, the techniques described herein relate to a method, wherein the neighbor-probe request includes a basic service set identifier (BSSID) element indicating a list of BSSIDs of one or more neighboring AP MLDs for which probe-response information is requested.

In some aspects, the techniques described herein relate to a method, wherein the BSSID element is included in the multi-link element of the neighbor-probe request.

In some aspects, the techniques described herein relate to a method, wherein the neighbor-probe request includes a query frame that causes one or more probe neighbor-probe responses representing the one or more neighboring APs to be sent to the station.

In some aspects, the techniques described herein relate to a method, wherein the neighbor-probe request is sent to the serving AP using a protected management frame.

In some aspects, the techniques described herein relate to a method, wherein the neighbor-probe request elicits the neighbor-probe response for a single neighboring AP MLD, when the one or more neighboring APs consists of the single neighboring AP MLD.

In some aspects, the techniques described herein relate to a method, wherein collecting the probe-response information that is requested in the neighbor-probe request includes forwarding, by the serving AP and over a wired distribution system network, the neighbor-probe request to selected neighboring APs and/or AP MLDs.

In some aspects, the techniques described herein relate to a method, wherein: collecting the probe-response information that is requested in the neighbor-probe request includes sending, by the serving AP and over a wired distribution system network, information of the neighbor-probe request to selected neighboring APs and/or AP MLDs, and collecting the probe-response information further includes receiving, in response to the forwarded neighbor-probe request, probe-response frames from the selected neighboring APs and/or AP MLDs.

In some aspects, the techniques described herein relate to a method, wherein collecting the probe-response information that is requested in the neighbor-probe request includes retrieving, by the serving AP and over a wired distribution system network, the probe-response information from a neighbor AP database.

In some aspects, the techniques described herein relate to a method, wherein the neighbor AP database is updated periodically with latest neighbor AP information.

In some aspects, the techniques described herein relate to a method, wherein: collecting the probe-response information that is requested in the neighbor-probe request includes retrieving, by the serving AP and over a wired distribution system network, the probe-response information from a neighbor AP database, the neighbor AP database is updated periodically with latest neighbor AP information, and the latest neighbor AP information includes a latest basic service set (BSS) load, a BPCC, and/or other static and dynamic information for the one or more neighboring APs.

In some aspects, the techniques described herein relate to a method, further including: filtering, at the serving AP, the probe-response information after the serving AP collects the probe-response information for the one or more neighboring APs, wherein filtering the probe-response information is based on BPCC information received from the station, and sending the neighbor-probe response includes sending profile information for an affiliated AP when the BPCC information indicates that BSS parameters have changed since a last acquired BPCC by the station for that affiliated AP.

In some aspects, the techniques described herein relate to a method, further including: filtering, at the serving AP, the probe-response information according to a predefined policy after the serving AP collects the probe-response information for the one or more neighboring APs, wherein the predefined policy limits the probe-response information to APs on a same floor as the serving AP.

In some aspects, the techniques described herein relate to a method, sending the profile information for the affiliated AP includes sending complete profile information.

In some aspects, the techniques described herein relate to a method, sending the profile information for the affiliated AP includes sending partial profile information.

In some aspects, the techniques described herein relate to a method, further including: sending, in response to the neighbor-probe request and as part of the neighbor-probe response from the serving AP to the station, a complete profile for a neighboring AP, the complete profile providing all elements that are determined by the serving AP as applicable to the station.

In some aspects, the techniques described herein relate to a method, further including: sending, in response to the neighbor-probe request and as part of the neighbor-probe response from the serving AP to the station, a complete profile for a neighboring AP or a partial profile for a neighboring AP providing only elements that are requested in one or more request elements or in one or more extended request element in the neighbor-probe request.

In some aspects, the techniques described herein relate to a method, wherein the neighbor-probe response from the serving AP to the station always includes a BSS Load element for each reported neighboring AP for which the probe response is provided whether or not the BSS Load element was requested by the station.

In some aspects, the techniques described herein relate to a method, further including: sending, as part of the neighbor-probe response from the serving AP, multiple probe response frames for the one or more neighboring APs as part of an aggregated MAC protocol data unit (A-MPDU) that is sent to the station; sending, as part of the neighbor-probe response from the serving AP, the multiple probe response frames for the one or more neighboring APs or neighboring AP MLDs as part of separate probe response frames that are sent to the station; or sending, as part of the neighbor-probe response from the serving AP, a neighbor-probe-response frame that is configured to embed frame bodies for multiple probe responses from the one or more neighboring APs or neighboring AP MLDs in a single neighbor probe response frame.

In some aspects, the techniques described herein relate to a method, further including: sending, as part of the neighbor-probe response from the serving AP, multiple probe response frames for the one or more neighboring APs as part of separate probe response frames that are sent to the station.

In some aspects, the techniques described herein relate to a method, further including: sending, as part of the neighbor-probe response from the serving AP, a neighbor-probe-response frame that is configured to embed frame bodies for multiple probe responses from the one or more neighboring APs in a single neighbor probe response frame.

In some aspects, the techniques described herein relate to a method, wherein the neighbor-probe-response frame is defined using a BSS identifier (BSSID) or an AP MLD identifier.

In some aspects, the techniques described herein relate to a method, wherein when the neighbor-probe-response frame is defined using the AP MLD identifier, and a probe response frame body is configured to allow fragmentation of the probe response frame body across multiple neighbor probe response frames.

In some aspects, the techniques described herein relate to a method, wherein the fragmentation of the probe response frame body across the multiple neighbor probe response frames is performed using a same method as for beacon-report fragmentation in a baseline 802.11 specification.

In some aspects, the techniques described herein relate to a method, wherein the multiple probe response frames are either multi-link responses or non multi-link probe responses.

In some aspects, the techniques described herein relate to a method, further including: filtering, at the serving AP, the probe-response information according to a predefined policy after the serving AP collects the probe-response information for the one or more neighboring APs, wherein the predefined policy filters 1-hop to restrict the probe-response information to a subset of APs on a same floor as the serving AP.

In some aspects, the techniques described herein relate to a method, wherein sending the neighbor-probe response includes sending in the neighbor-probe response as protected management frames for the one or more neighboring APs.

In some aspects, the techniques described herein relate to a method, wherein: the neighbor-probe request is a first management frame that is a neighbor AP discovery request frame, and the neighbor-probe response is a second management frame that is a neighbor AP discovery response frame.

In some aspects, the techniques described herein relate to a method, wherein elements of the neighbor AP discovery request frame are restricted to elements used for neighbor AP discovery.

In some aspects, the techniques described herein relate to a method, wherein the neighbor AP discovery request frame includes indicia whether the probe-response information is requested for the one or more neighboring APs or beacon information is requested for the one or more neighboring APs.

In some aspects, the techniques described herein relate to a method, wherein: the elements included in the neighbor-probe request are restricted to elements used for neighbor AP discovery.

In some aspects, the techniques described herein relate to a method, wherein: the neighbor-probe request includes indicia whether the probe-response information is requested for the one or more neighboring APs or beacon information is requested for the one or more neighboring APs, and when the neighbor-probe request includes a request for beacon information for the one or more neighboring APs, the serving AP collects a beacon frame body from each of the one or more neighboring APs for which the beacon information is requested. Architectural infrastructure 238 can be walls, pillars, or other physical structures that can be obstacles to wireless transmissions and movement throughout single floor 211.

In some aspects, the techniques described herein relate to a method, wherein the neighbor AP discovery request frame includes a request element that provides a list of elements indicating which elements to be returned in respective beacons.

In some aspects, the techniques described herein relate to a method, wherein: the neighbor-probe request includes a request element and/or an extended request element that provides a list of elements indicating which elements to be returned in respective beacons, when one or more request elements or extended request element, are included in the neighbor-probe request from the station, the serving AP filters the information from the respective beacons to restrict information returned in a beacon included in the neighbor-probe response to information in the beacon that corresponds to the one or more request elements and/or extended request element, and when the request element and/or extended request element is absent from the neighbor-probe request, the serving AP returns all elements in the beacon frame body for a neighboring AP.

In some aspects, the techniques described herein relate to a method, wherein, when the request element is absent from the neighbor AP discovery request frame, the serving AP returns all elements in the beacon frame body for a neighboring AP.

In some aspects, the techniques described herein relate to a method, wherein: the neighbor-probe request includes BPCC values for one or more affiliated APs of neighboring AP MLDs, when BPCC values are included for one or more affiliated APs of neighboring AP MLDs in the neighbor-probe request, the serving AP returns beacon information in the neighbor-probe response only for those affiliated APs for which the BPCC information indicates that BSS parameters have changed since a last acquired BPCC by the station for that affiliated AP.

In some aspects, the techniques described herein relate to a method, further including: filtering, at the serving AP, the beacon information after the serving AP collects the beacon information for the one or more neighboring APs, wherein filtering the probe-response information is based on BPCC information to select the beacon information for the neighboring APs indicating an updated BPCC value compared to BPCC value received from the station for the one or more neighboring APs.

In some aspects, the techniques described herein relate to a method, further including: filtering, at the serving AP, the beacon information after the serving AP collects the beacon information for the one or more neighboring APs, wherein filtering the probe-response information is based on BPCC information to select the beacon information for the neighboring APs indicating an updated BPCC value compared to BPCC value received from the station for the one or more neighboring APs.

In some aspects, the techniques described herein relate to a method, further including: filtering, at the serving AP, the probe-response information according to a predefined policy after the serving AP collects the probe-response information for the one or more neighboring APs, wherein the predefined policy selects neighboring APs beacon information for the neighboring APs on a same floor as the serving AP.

In some aspects, the techniques described herein relate to a method, sending, by the serving AP, beacon frames for multiple neighboring APs in the neighbor AP discovery response frame, wherein multiple beacon frame bodies for the neighboring APs are embedded in a same response frame.

In some aspects, the techniques described herein relate to a method, wherein the beacon frame body is configured for fragmentation across multiple response frames using a same method of fragmenting frames as a fragmentation method for Beacon reports in a baseline 802.11 specification.

In some aspects, the techniques described herein relate to a method, wherein the neighbor AP discovery request frame and the neighbor AP discovery response frame is sent as a protected management frame between the station and the serving AP.

In some aspects, the techniques described herein relate to a computing apparatus including: a processor; and a memory storing instructions that, when executed by the processor, configure the apparatus to perform one or more of the above-described methods.

In some aspects, the techniques described herein relate to a non-transitory computer-readable storage medium, the computer-readable storage medium including instructions that when executed by a computer, cause the computer to perform one or more of the above-described methods.

### EXAMPLE EMBODIMENTS

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art for improved roaming. In Wi-Fi 8, support for seamless or smooth roaming capability is a strong consideration for improving Wi-Fi roaming quality. The systems and methods disclosed herein can improve seamless roaming by defining a mechanism for a client (or station) to tunnel query requests for discovering information for neighboring APs through a serving AP MLD and receive probe responses or beacon frame body for neighboring APs/AP MLDs through the serving AP. This enables clients to collect information about potential roaming targets without requiring clients to perform off-channel scanning to collect neighboring APs information. Thus, the client and AP can continue to meet quality of service (QoS) for low-latency applications during roaming procedures, resulting in seamless roaming. Seamless roaming is achieved due to less disruption to ongoing download and upload transmissions with the serving AP, which is especially relevant for single-radio clients.

In previous neighbor discovery processes for roaming, a roaming station (STA), which can be a non-AP MLD (non-access point multi-link device) queries which AP MLDs are available for roaming using a probe request and response for neighboring APs or uses a query for beacon information for neighboring APs. This query process can consume wireless bandwidth that is then unavailable for other communications with the STA.

For example, in the Ultra High Reliability Study Group (UHR SG) and 802.11bn (i.e., Wi-Fi 8), there are proposals for roaming enhancements to support more reliable and seamless roaming. Roaming requires clients e.g., the STAs) to determine potential target APs or target AP MLDs to select a roaming target. For this, a client (e.g., the STA) needs to perform off-channel scan for roaming target APs by listening to beacons or sending Probe Request and receiving Probe Responses, impacting ongoing transmissions for the client with the current serving AP (especially for single radio clients), which may impact quality of service (QoS) for low latency applications.

The systems and methods disclosed herein provide seamless roaming and provide the requested QoS for low latency applications during the roaming procedure by reducing the amount of signaling with the client for the neighbor discovery process. For example, the systems and methods disclosed herein minimize the amount of off-channel scanning to be done by the client to determine roaming targets. The systems and methods disclosed herein provide a mechanism for tunneling query requests (including probe requests and request for beacon information) for neighboring APs through the serving AP. This enables a client to request information for neighboring APs through current serving AP, to minimize the amount of off-channel scanning needed for roaming

In previous approaches for roaming, clients determine potential candidate targets to roam to. Typically, the client would have to do an off-channel scan to figure out good or desirable roaming targets (e.g., based on Received Signal Strength Indicator (RSSI) measurements). As a result of this off channel scan, the client can receive the beacon information from the target AP, as well as the probe response information, which has the basic service set (BSS) parameters for the target AP. The problem with the previous approach is that when the client is performing the off-channel scan it consumes bandwidth that is then unavailable for other communication. For example, the beacon can be transmitted roughly every hundred milliseconds, so client has to wait, on an average, for fifty milliseconds per neighbor AP, and if it has to do for multiple neighbor APS, that adds to the off-channel scan delay. Further, if the client has to get the probe responses, it has to do this active probe request-response exchange that takes additional time, and doing that for multiple neighboring APS also adds up to the time taken for the off-channel scan. And the time when the client is doing the off-channel scan is time when the client is not performing transmission with the current AP, impacting the connectivity with the current AP. In Wi-Fi 8 (IEEE 802.11.bn), this time spent for off-channel scans undermines the goal of seamless roaming and QoS performance for the connectivity with the current AP. The systems and methods disclosed herein address this challenge.

The systems and methods disclosed herein can improve roaming by enabling a client to request information for multiple neighboring APs once from a serving AP, as opposed to requesting once per AP of the multiple neighboring APs. The serving AP then manages collection of the information from the multiple APS. The serving AP can collect the information from the neighboring APs using a probe request/response or by requesting beacon information from its neighboring APS, and, therefore, the approach used by the systems and methods disclosed herein does not have to go off channel to receive the requested information. According to certain non-limiting examples, this approach is realized by extending the probe request frame or by defining another management frame to request probe response information for one or more neighboring APS or neighboring AP MLDs through the serving AP. Using this approach, all the probe response information can be tunneled through the serving AP without going off channel.

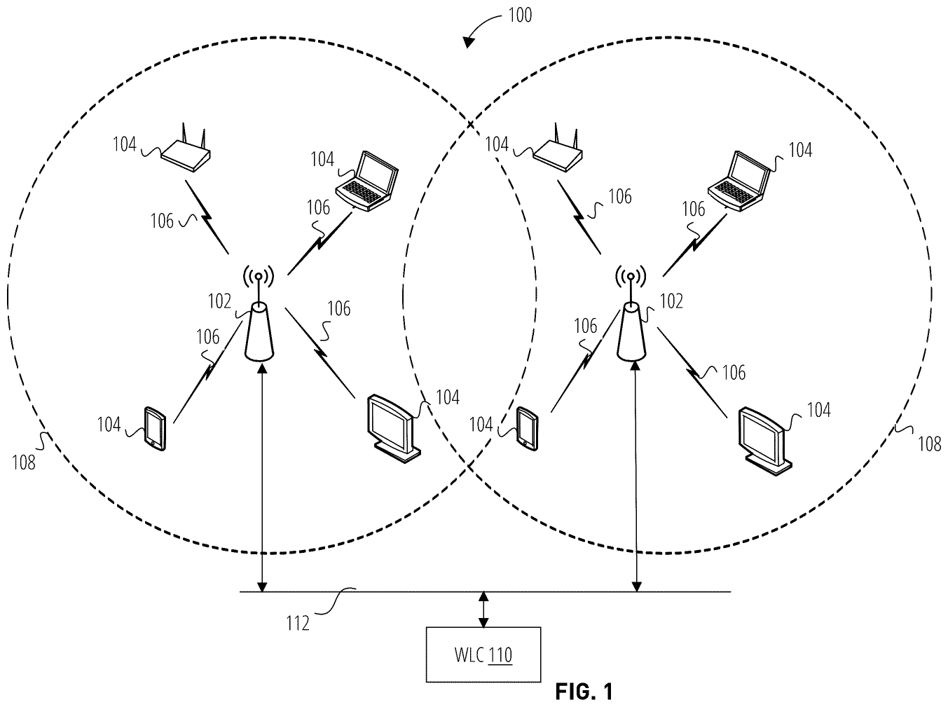

FIG. 1 illustrates a block diagram of an example wireless communication network according to some aspects of the present disclosure. According to some aspects, wireless communication network 100 may be an example of a wireless local area network (WLAN) such as a Wi-Fi network. For example, wireless communication network 100 may be a network implementing at least one of the IEEE 802.11 family of wireless communication protocol standards and amendments thereof (such as that defined by the IEEE 802.11-2016 specification or amendments thereof including, but not limited to, 802.11ay, 802.11ax, 802.11az, 802.11ba and 802.11be). Additionally, wireless communication network 100 may implement future versions and amendments of wireless communication protocol standards and amendments thereof such as 802.11bn and be modified according to the present disclosure to include the features contained herein. The wireless communication network 100 may include numerous wireless communication devices such as an AP actor, which can be one or more of a non-MLD AP, an AP affiliated with an AP MLD, and/or an AP MLD. In the examples presented herein, the AP actor can exclude an upper UMAC. Therefore, the AP actor can include the lower UMAC, LMAC, and/or PHY. Additionally, the WLAN can include one or more of STA actors 104, which can be one or more of a non-MLD STA, a STA affiliated with a Non-AP MLD, and/or a Non-AP MLD. As illustrated, wireless communication network 100 also may include multiple AP actors such as AP actors 102 (may also be referred to as simply AP). AP actors 102 can be coupled to one another through backhaul distribution system 112 that is connected to wireless LAN controller 110. This example is non-limiting, and although AP actors 102 are shown as being coupled to one another through backhaul distribution system 112, the network can provide another device that allows the coupling of the multiple AP actors.

Each of STA actors 104 also may be referred to as a mobile station (MS), a mobile device, a mobile handset, a wireless handset, an access terminal (AT), a user equipment (UE), a subscriber station (SS), client, or a subscriber unit, among other examples. STA actors 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other examples. In other examples, the STA actors 104 can be referred to as clients and/or client devices.

Any one of the AP actors 102 and an associated set of STA actors (e.g., STA actors 104) may be referred to as a basic service set (BSS), which is managed by a respective AP actor of AP actors 102. FIG. 1 additionally shows an example coverage areas 108 of the each of AP actors 102, which may represent a basic service area (BSA) of wireless communication network 100. As illustrated, three of STA actors 104 are within the BSA of each of AP actors 102. The BSS may be identified to users by a service set identifier (SSID), where the BSS might be one of many in the SSID. The BSS may be identified to other devices by a unique (or substantially unique) basic service set identifier (BSSID). One or more of AP actors 102 periodically broadcasts beacon frames (“beacons”) including the BSSID to enable STA actors 104 within wireless range of AP actors 102 to “associate” or re-associate with AP actors 102 to establish a respective communication link of communication links 106 (hereinafter also referred to as a “Wi-Fi link”), or to maintain the communication links 106, with the AP actors 102. For example, the beacons may include an identification of a primary channel used by the respective AP actor of AP actors 102 as well as a timing synchronization function for establishing or maintaining timing synchronization with AP actors 102. AP actors 102 may provide communication links 106 to STA actors 104 and therefore access to external networks. While the example has been described in regard to AP actors 102 and STA actors 104, the present disclosure extends such that an AP actor may provide access to external networks to various STA actors in a WLAN via the communication links 106.

To establish the communication links 106 with any one of AP actors 102, each of STA actors 104 is configured to perform passive or active scanning operations (“scans”) on frequency channels in one or more frequency bands (for example, the 2.4 GHz, 5 GHz, 6 GHz or 60 GHz bands). To perform passive scanning, STA actors 104 listen for beacons, which are transmitted by a respective AP actor of AP actors 102 at or near a periodic time referred to as the target beacon transmission time (TBTT) (measured in time units (TUs) where one TU may be equal to 1024 microseconds (μs)). To perform active scanning, STA actors 104 generate and sequentially transmits probe requests on each channel to be scanned and listens for probe responses from AP actors 102. STA actors 104 may be configured to identify or select an AP and thence a selected AP actor of AP actors 102 with which to associate based on the scanning information obtained through the passive or active scans, and to perform authentication and association operations to establish communication links 106 with the selected AP actor of AP actors 102. The selected AP actor of AP actors 102 assigns an association identifier (AID) to STA actors 104 at the culmination of the association operations, which selected AP actor of AP actors 102 uses to improve the efficiency of certain signaling to the STA actors 104.

The present disclosure modified the WLAN radio and baseband protocols for the PHY and medium access controller (MAC) layers. AP actors 102 and STA actors 104 transmit and receive wireless communications (hereinafter also referred to as “Wi-Fi communications”) to and from one another in the form of PHY protocol data units (PPDUs). AP actors 102 and STA actors 104 also may be configured to communicate over other frequency bands such as shared licensed frequency bands, where multiple operators may have a license to operate in the same or overlapping frequency band or bands.

Each PPDU is a composite structure that includes a PHY preamble and a payload in the form of one or more PHY service data unit (PSDU). The information provided in the preamble may be used by a receiving device to decode the subsequent data in an intended PSDU. In instances in which PPDUs are transmitted over a bonded channel, selected preamble fields may be duplicated and transmitted in each of the multiple component channels.

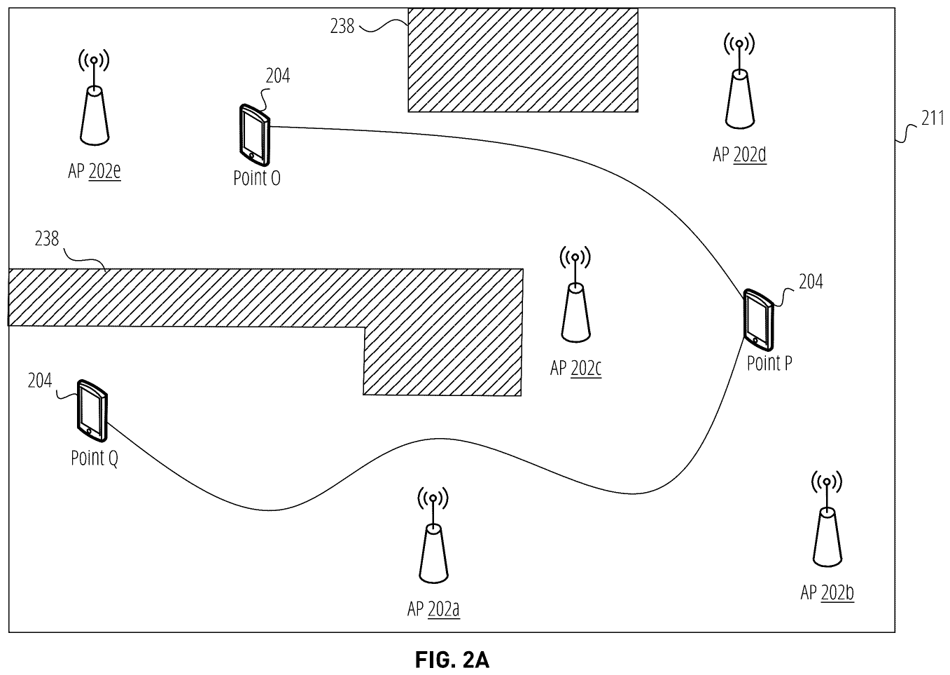

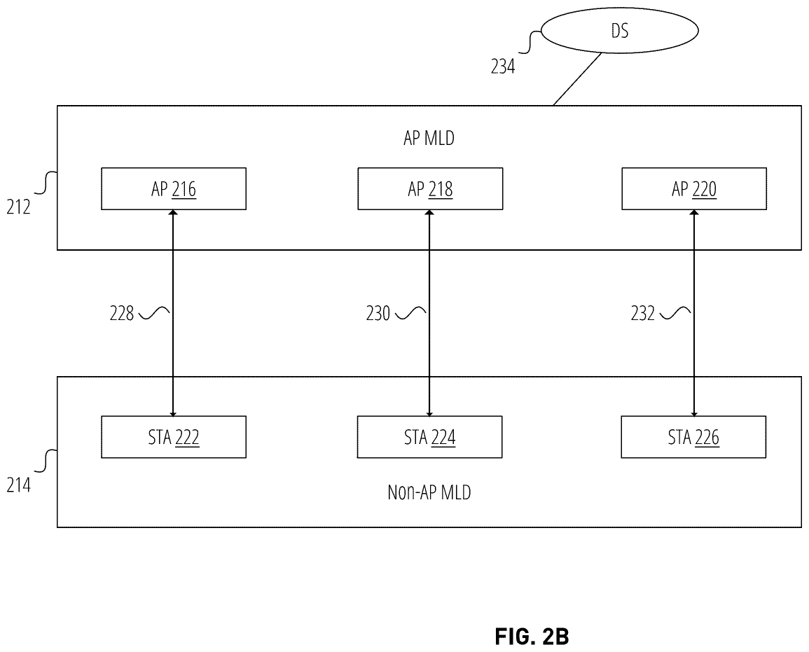

FIG. 2A illustrates an example of a single floor of building equipped with wireless communication according to some aspects of the present disclosure. While only a single floor is illustrated a description equally applies to multiple floors in a building. Additionally, some of the floors in a building may not be contiguous, such that floors 1, 3, 4, and 8 span a network for a building that has floors 1-10. Thus, in at least one implementation the building can include one or more floors that do not have a network including one or more AP actors. As illustrated, single floor 211 includes AP actors (e.g., AP actor 202a, AP actor 202b, AP actor 202c, AP actor 202d, and AP actor 202e). Each of the AP actors can have a respective coverage area such that an overall coverage area can span substantially the entire floor. In other examples, the overall coverage area can extend beyond the entire floor. In other examples, the overall coverage area can extend beyond the entire floor. Additionally, the coverage of an AP actor of AP actors may substantially overlap with the coverage of another AP actor of AP actors.

As illustrated by the line between points Q, P, and O, STA actor 204 can move from point O to point P to point Q. When a STA actor 204 is moving around on a given floor, one or more of the AP actors can be considered to be nearest to the STA actor 204. Nearest as used in relation to the AP actors and STA actor 204 can include being physically nearest (for example, a Euclidean distance on the floor) and/or pathloss-nearest (for example, having the lowest wireless attenuation (pathloss) between AP actor, among all the AP actors, and STA actor). Additionally, using the pathloss-nearest approach can reduce the likelihood of connection between an AP actor on a floor above or below the STA actor 204. The location of the AP actor on the floor above or below might be closer in a Euclidean sense, but also not be a desirable AP for the connection of the device or station due to the floor location and/or possible signal interruption. The location of the AP actor on the floor above or below might be closer in a straight line and/or Euclidean sense, but also not be a desirable AP for the connection of the device or station due to the floor location and/or possible signal interruption. Additionally, the coverage of one or more AP actors can at least partially overlap with the coverage of one or more other AP actors. The present disclosure provides for selecting the AP actor and/or providing a communication pathway from one or more STA actors through one or more AP actors.

FIG. 2B depicts an illustrative schematic diagram for MLO between an AP MLD with affiliated logical entities and a Non-AP MLD (or STA) with affiliated logical entities according to some aspects of the present disclosure.

Referring to FIG. 2B, two multi-link logical entities AP MLDs 212 and Non-AP MLDs 214 are shown. AP MLDs 212 may include physical and/or logical affiliated AP such as AP 216, AP 218, and AP 220 operating in different channels and typically different frequency bands (e.g., 2.4 GHz, 5 GHz, and 6 GHz). AP 216, AP 218, and AP 220 may be the same as or similar to any one of the APs described above. Non-AP MLDs 214 may include STA 222, STA 224, and STA 226, which may be the same as or similar to any of the STAs as described herein.

AP 216 may communicate with STA 222 via link 228. AP 218 may communicate with STA 224 via link 230. AP 220 may communicate with STA 226 via link 232.

AP MLDs 212 is shown in FIG. 2B to have access to a distribution system (DS) such as DS 234, which is a system used to interconnect a set of BSSs to create an extended service set (ESS).

It should be understood that although the example shows three logical entities within the AP MLD and the three logical entities within the Non-AP MLD, this is merely for illustration purposes and that other numbers of logical entities within each of the AP MLD and Non-AP MLD may be envisioned. The example Wi-Fi systems and MLO described above with reference to FIG. 1, FIG. 2A, and FIG. 2B provide examples of simplified and example systems of the present disclosure.

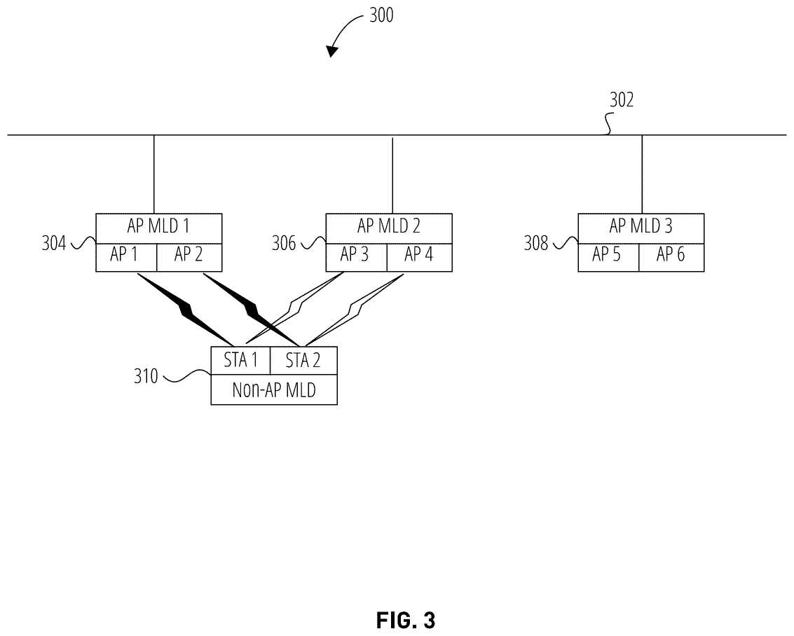

FIG. 3 illustrates an example of a seamless mobility domain according to some aspect of the present disclosure.

FIG. 3 illustrates an example architecture of a Seamless Mobility Domain (SMD) shown as SMD 300 that includes a DS 302 that is a logically connected entity that includes AP MLD 304, AP MLD 306, and AP MLD 308, all of which can form an ESS (e.g., all AP MLDs which are part of a campus ESS network). SMD 300 also shows a Non-AP MLD 310 (which can also be referred to as a station or STA) that may be connected to AP MLD 304.

AP MLD 304 may include one or more APs such as AP1 and AP2. AP1 and AP2 may be different physical APs (or AP interfaces) co-located in AP MLD 304. Similarly, AP MLD 306 may include one or more APs such as AP3 and AP4. AP3 and AP4 may be different physical APs (or AP interfaces) co-located in AP MLD 306. Similarly, AP MLD 308 may include one or more APs such as AP5 and AP6. AP5 and AP6 may be different physical APs (or AP interfaces) co-located in AP MLD 308. The number of AP MLDs and/or the number of respective APs of each AP MLD is not limited to the example numbers shown in FIG. 2B and may include more or less.

In one example, AP MLD 304, AP MLD 306, and AP MLD 308 may be located in different geographical locations (e.g., different rooms of the same building, different floors of the same building, different buildings of the same campus or area, etc.). This may be referred to as non-co-located AP MLDs.

Non-AP MLD 310 may be any known or to-developed device capable of establishing one or more wireless communication links with one or more of AP MLD 304, AP MLD 306, and/or AP MLD 308. As a non-limiting example, Non-AP MLD 310 may be a mobile device having two wireless interfaces, each of which may correspond to one of STA 1 or STA 2. In one example, each one of STA 1 and STA 2 may operate on a different link (e.g., 5 GHz for STA 1 and 6 GHz for STA 2). The number of Non-AP MLDs and/or STAs associated with each is not limited to that shown in FIG. 3 and may be more or less.

As shown in FIG. 3, Non-AP MLD 310 is associated with SMD 300, with multiple links setup with the AP MLD 304 (for example, 2.4 GHz link with the AP1 for STA 1 and 5 GHz link with the AP2 for the STA 2). For one of the links (for example, 2.4 GHz), Non-AP MLD 310 may detect a weak RSSI. As a result, Non-AP MLD 310 determines a specific roaming target AP3 of AP MLD 306 for that link to switch to. Similarly, the same process may be performed for the other link (for example, the 5 GHz) to switch to a link with STA 4 on AP MLD 306.

In order to support seamless link level roaming for an ESS/NID/MDM/SMD (e.g., for MBBR), by way of an example, seamless link level roaming may be initiated by the current AP MLD (e.g., AP MLD 304). Alternatively, seamless link level roaming may be based upon a request received from the Non-AP MLD (e.g., Non-AP MLD 310). Current AP MLD (may also be referred to as the source AP MLD) may send a frame, for example, a BSS Transition Management Request frame or any other known or to be developed management frame, to indicate to the Non-AP MLD one or more of: a) one or more ‘delete link’ operations for link(s) of the current AP MLD (in the old MLD's link ID space); and/or b) one or more ‘add link’ operations for link(s) of a new Target AP MLD such as the AP MLD 306 (in the new MLD's link ID space), wherein the current AP MLD may indicate ‘add link’ operations for multiple candidate Target AP MLDs.

As described herein, the link space can be defined and identified corresponding to each AP MLD by the respective AP MLD MAC Address field included in the Reconfiguration ML element. Accordingly, the frame, such as the BSS Transition Management Request frame, may include multiple Reconfiguration Multi-Link elements. Each Reconfiguration Multi-Link element of the multiple Reconfiguration Multi-Link elements corresponds with each AP MLD for which either a link add, or a link delete operation is indicated in the frame. Further, as described herein, the link add operation may be indicated for multiple roaming candidate Target AP MLDs within the Link Reconfiguration Notify frame. In the Reconfiguration Multi-Link element, the MLD MAC Address may be set to the MLD MAC Address of the AP MLD for which the link add or the link delete operation is indicated.

Support for seamless/smooth roaming capability is a consideration for Wi-Fi 8 to improve Wi-Fi roaming quality. To support smooth roaming/mobility in network (e.g., a geographically dispersed network such as on a campus wide Wi-Fi network), clients can create association with the campus-network/ESS instead of with an individual AP MLD. The ESS might be represented by a mobility domain or, in the case that the network is a global network, then there can be multiple “sub-mobility domains” within a mobility domain, each of which can map to a single campus.

A client such as the Non-AP MLD 310 currently creates its association with the ESS network such as SMD 300, instead of associating with a single AP MLD (e.g., AP MLD 304, AP MLD 306, and/or AP MLD 308) within the ESS. Such an architecture will enable a client to roam seamlessly between AP MLDs without requiring (re)association and reestablishment of contexts with each new AP MLD, since the client associates with the SMD covering all the AP MLDs of the ESS. Such an architecture can significantly reduce roaming time to realize seamless roaming. Signaling procedures to enable such seamless roaming are described in the present disclosure.

In Wi-Fi 7/802.11be, a Non-AP MLD associates with an AP MLD according to known or to be developed procedures. In Wi-Fi 8, a Non-AP MLD associates with an SMD (e.g., SMD 300) or SMD MLD (or NID or MDM) that cover multiple APs/AP MLDs of an ESS. In a Distributed MLO architecture for seamless roaming, multiple AP MLDs that are part of an SMD/SMD MLD would have a common Upper Upper MAC (U-UMAC) that provides a single MAC SAP to the DS covering the multiple APs/AP MLDs of the SMD/SMD MLD. In such a Distributed MLO architecture, a Non-AP MLD can have link setup with one or more AP MLDs within an SMD/SMD MLD.

For both cases (Wi-Fi 7 and Wi-Fi 8), the present disclosure introduces a mechanism to enable switch link operation to switch a current link to a new link (either within an AP MLD or across two AP MLDs) atomically. An atomic switch link operation may be defined as one where the entire operation either succeeds fully or is not executed (e.g., a delete link operation and an add link operation succeed together or else none would be carried out). This ensures that the Non-AP MLD would not end up in a situation where its current link got deleted, but the new link did not get added to its ML setup (e.g. because the AP or the associated link is already too crowded and a new STA can't be accepted on that link). This will be described in more detail below.

The 802.11be amendment defines the Link Reconfiguration Request/Response frames for add link and delete link operations. Using this, as described herein, a switch link operation can be achieved by including both delete link and add link within the same request frame.

In currently implemented/adopted procedures, the existing AP always accepts the delete link operation, not knowing the intent of the Non-AP MLD (e.g., to add a new link). The present disclosure proposes enhancements that address these deficiencies. More specifically, the proposed enhancements to the 802.11be Link Reconfiguration Request/Response signaling include providing support for an atomic switch link operation in the protocol within an AP MLD and across multiple AP MLDs (for roaming scenario).

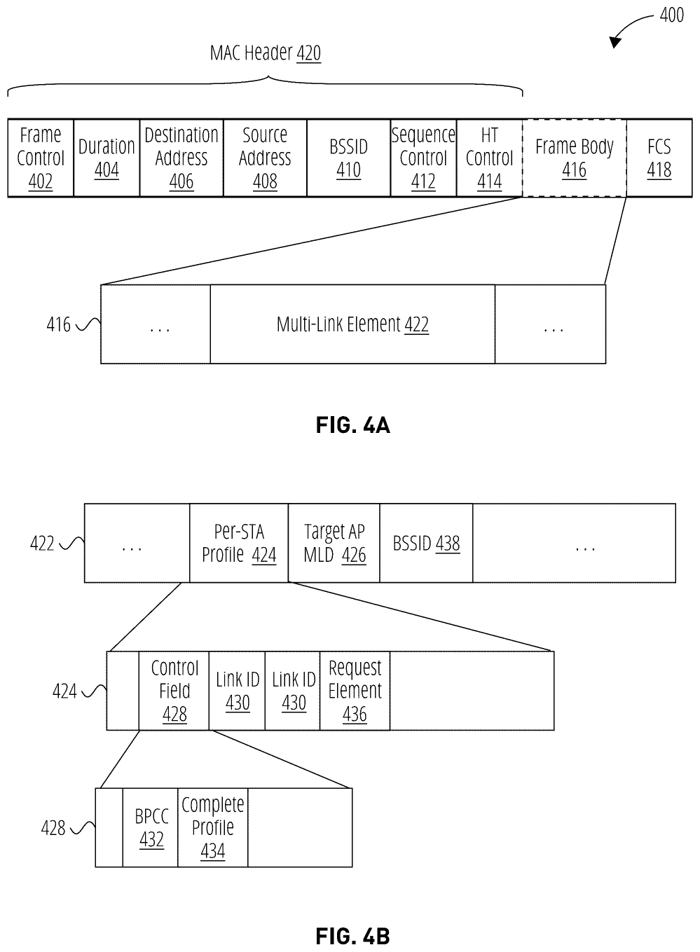

FIG. 4A illustrates an example of probe-request frame 400. Probe-request frame 400 can include MAC header 420 (which includes frame control 402, duration 404, destination address 406, source address 408, BSSID 410, sequence control 412, and HT control 414), frame body 416, and FCS 418, Further, frame body 416 can include multi-link element 422.

For example, many of the elements shown in FIG. 4A can the same or similar to those defined for Probe Request and Probe Response frames are defined for basic service set (BSS) Transition Management in 802.11v and/or for Radio Resource Management in 892.11k. The Neighbor Probe Request and Neighbor Probe Response frames can allow devices to query and provide information about nearby access points (APs) and their capabilities. The Neighbor Probe Request and Neighbor Probe Response frames can be in the Management frames category.

According to certain non-limiting examples, the Neighbor Probe Request frame can have a 2-byte “frame control” element that identifies the frame type and subtype. For a Neighbor Probe Request, the subtype can be 0x0A (Management frame, subtype: Neighbor Request). The Neighbor Probe Request frame can have a 2-byte “duration” element, which is set to 0, for example. The Neighbor Probe Request frame can have a 6-byte “destination address” element, which can be the address of the serving AP. The Neighbor Probe Request frame can have a 6-byte “source address” element, which is the MAC address of the STA sending the request. The Neighbor Probe Request frame can have a 6-byte “BSSID” element, which can be the address of the AP for which the probe-response information is requested. The Neighbor Probe Request frame can have a 2-byte “sequence control” element representing a sequence number and/or fragment number. The Neighbor Probe Request frame can have a variable size frame body that represents fields containing specific details requested from the neighboring AP MLDs (such as the list of neighboring BSSIDs, SSID, etc.).

According to certain non-limiting examples, the Neighbor Probe Response frames are sent by an AP to an STA in response to the Neighbor Probe Request, providing details about the neighboring APs. The Neighbor Probe Response frame can have a 2-byte “frame control” element that identifies the frame type and subtype. For a Neighbor Probe Response, the subtype can be 0x0B (Management frame, subtype: Neighbor Response). The Neighbor Probe Response frame can have a 2-byte “duration” element, which is set to 0, for example. The Neighbor Probe Response frame can have a 6-byte “destination address” element, which can be the address of the STA receiving the response. The Neighbor Probe Response frame can have a 6-byte “source address” element, which is the MAC address of the serving AP sending the response. Similar to the Neighbor Probe Request frame, the Neighbor Probe Response frame can also have a 6-byte “BSSID” element and a 2-byte “sequence control” element. The Neighbor Probe Response frame can have a variable size frame body that represents fields that containing specific details requested from the neighboring AP MLDs such at the multi-link element 422 described below.

FIG. 4B illustrates a non-limiting example of multi-link element 422 of probe-request frame 400. Multi-link element 422 can, be for example, a ‘Neighbor Probe Request Multi-Link element’ that enables requesting probe response information for neighboring APs. This element can include an identifier for the target AP MLD (e.g., ID for target AP MLD 426) for which probe-response information is requested. For example, the target AP MLD can be identified by an AP MLD MAC Address or by an AP MLD identifier (ID) that is obtained from the Reduced Neighbor Report (RNR). Additionally or alternatively, the target AP MLD can be identified by another equivalent identifier for the target AP MLD. The AP MLD identifier can be included as part of the Common Information field in the multi-link element 422.

According to certain non-limiting examples, multi-link element 422 can include one or more Per-STA Profile sub-elements (e.g., Per-STA Profile 424), and the one or more Per-STA Profile sub-elements can indicate Link IDs (e.g., link IDs 430) for affiliated APs whose information is requested. If no Per-STA Profile sub-elements are included, then probe-response information is requested for all affiliated APs of the target AP MLD.

According to certain non-limiting examples, multi-link element 422 can include an STA Control field (e.g., control field 428) in the Per-STA Profile sub-element, and the STA Control field can include BPCC 432 indicating the last known BPCC (BSS Parameters Change Count) for the affiliated AP. For example, in the scenario when the STA has acquired the neighbor AP information in the past, BPCC 432 can be used as a filtering criterion by the serving AP before sending the probe-response information the STA.

According to certain non-limiting examples, multi-link element 422 can include a Complete Profile subfield (e.g., complete profile 434) in the STA Control field. The Complete Profile subfield In the STA Control field can be used to request either a complete profile or a partial profile for an affiliated AP (e.g., as defined in the 802.11be draft). When a partial profile is requested (e.g., by setting Complete Profile=0), then the STA Profile field may include Request element and/or Extended Request element (e.g., request elements 436) that indicates specific elements which are requested to be returned for the affiliated AP. When no Request element and/or Extended Request element are included (e.g., request elements 436 is empty or absent), then other elements included in the Probe Request frame are used to determine which elements should be returned for neighboring APs.

Additionally or alternatively, in addition to indicating which neighboring AP MLDs are to be included in the probe-response information, the STA can use probe-request frame 400 to indicate a list of one or more BSSIDs 438 for neighboring APs for which probe-response information is requested. The list of BSSID can be indicated as part of Neighbor Probe Request Multi-Link element (e.g., multi-link element 422) or as a separate element in frame body 416 that indicates the list of BSSIDs.

According to certain non-limiting examples, the STA may not know the identifier for the target AP MLDs or target APs. For example, the Neighbor Probe Request Multi-Link element (e.g., multi-link element 422) can indicate that neighbor AP probe response information is requested for neighboring APs in 1-hop or 2-hops of the serving AP MLD without indicating identifiers for specific neighboring APs MLDs or APs. Additionally or alternatively, the STA can indicate a generic criterion to request all applicable neighboring APs information, and in this case it is left to the serving AP to determine for which neighboring APs/AP MLDs the probe response information should be provided.

According to certain non-limiting examples, probe-request frame 400 can be defined by extending an existing definition of a probe-request frame in a version of the IEEE 802.11 standard to define a new neighbor-probe-request frame. The neighbor-probe-request frame can include one or more Neighbor Probe Request Multi-Link elements (e.g., multi-link element 422 as discussed above), which indicates neighbor AP MLDs and optionally a subset of affiliated APs (e.g., indicated by link IDs 430) for each AP MLD for which a Probe Response is requested. Further, the STA can include last acquired BPCC information (if any) for affiliated APs in the Per-STA Profile sub-element (e.g., Per-STA Profile 424) as described above. The new neighbor-probe-request frame can include an SSID element or SSID List element (the same or similar to as in the existing definitions of a Probe Request) to indicate SSIDs for which neighbor APs information is requested. When no SSID information is indicated, then all SSIDs are applicable for providing probe responses for neighboring APs. Optionally, the new neighbor-probe-request frame can include another BSSID List element indicating a list of BSSIDs for neighboring APs for which probe response information is requested. This BSSID list can alternatively be included as part of the Neighbor Probe Request Multi-Link element. Further, the neighbor-probe request can be a query frame that causes one or more probe responses being sent to the STA for neighboring APs or AP MLDs. The neighbor-probe request can be sent as a protected management frame to the serving AP MLD.

The neighbor-probe request can be used to query probe either a response (singular) for single neighboring AP or AP MLD or responses (plural) for multiple neighboring APs or AP MLDs.

According to certain non-limiting examples, probe-request frame 400 and the corresponding probe-response frame can be defined as new Neighbor AP Discovery Request and Response frames. These can be Neighbor AP Discovery Request and Response management frames for requesting and providing Probe Responses from neighboring APs or AP MLDs through serving AP. The new Neighbor AP Discovery Request frame can be streamlined to only include those elements requested for querying the Neighbor AP information as discussed above, such that the new Neighbor AP Discovery Request does not include all the elements carried in the Probe Request frame as defined in current 802.11 baseline specification. This has the benefit of reducing the size of the request frame.

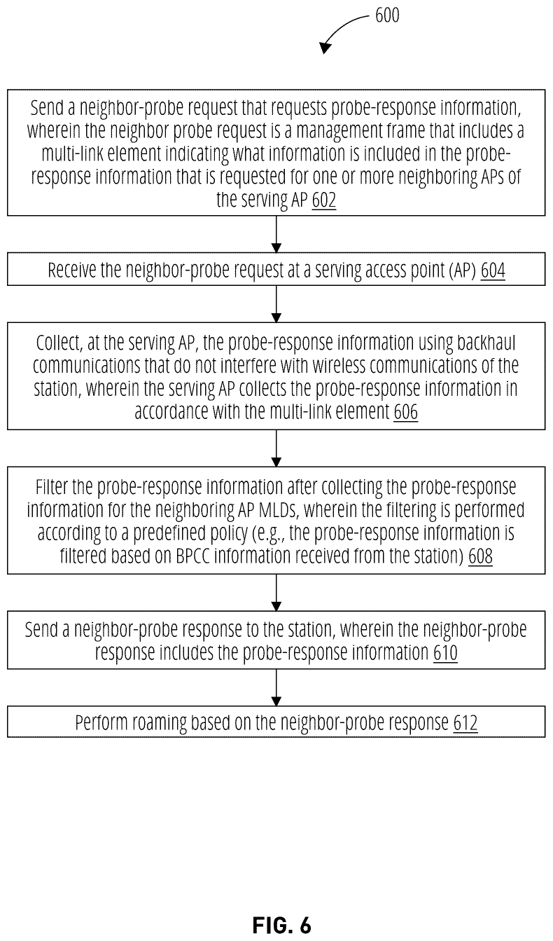

The Neighbor AP Discovery Request frame can be used to indicate whether either probe response information is requested or beacon information is requested for neighboring APs. When probe response information is requested, the serving AP collects, filters, and delivers probe responses for neighboring APs. When beacon information is requested for neighboring APs, the serving AP collects the latest Beacon frame body from each of the requested neighboring APs. The Neighbor AP Discovery Request frame can indicate specific elements to be returned in the beacon by including a Request Element and/or an Extended Request Element (e.g., request element 436) indicating list of elements which should be returned in beacon. As discussed below for method 600 in FIG. 6, the request elements 436 can be used by serving AP to apply filtering and only return those elements in the beacon which were requested according to request elements 436.

According to certain non-limiting examples, the Neighbor Report Request and Response frames can be defined by extending the existing request and response frames in 802.11 to provide the above-described functionality.

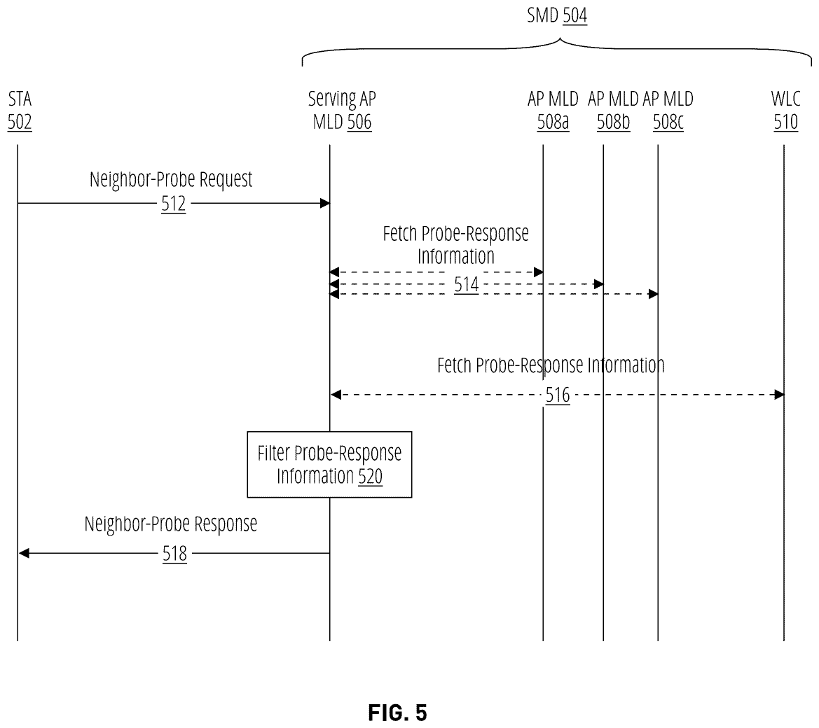

FIG. 5 illustrates an example of a neighbor AP MLD discovery process using neighbor-probe request and response signals between a Non-AP MLD (e.g., STA 502) and a serving AP MLD (e.g., serving AP MLD 506) to gather probe-response information from one or more neighbor AP MLDs (e.g., neighbor AP MLD 508a, neighbor AP MLD 508b, and neighbor AP MLD 508c) according to some aspects of the present disclosure.

The system in FIG. 5 includes a Seamless Mobility Domain (SMD) shown as SMD 504, which can be the same or similar to SMD 300. SMD 504 includes AP MLD 506, neighbor AP MLD 508a, neighbor AP MLD 508b, neighbor AP MLD 508c, and wireless LAN controllers 510.

According to certain non-limiting examples, STA 502 sends neighbor-probe request 512 to serving AP MLD 506. In response to neighbor-probe request 512, serving AP MLD 506 uses backhaul distribution system (DS) (e.g., backhaul distribution system 112) to obtain probe-response information regarding one or more neighboring AP MLDs to enable roaming. The dashed lines indicate communications using the DS. The DS can be a wired communication network or a wireless communication network. By using a wired DS to gather the probe-response information, the system avoids roaming probe requests and responses between STA 502 and the neighbor AP MLDs (e.g., neighbor AP MLD 508a, neighbor AP MLD 508b, and neighbor AP MLD 508c) thereby preserving wireless bandwidth for other communications with STA 502.

According to certain non-limiting examples, instead of using the DS to gather the requested information, the AP may collect probe response using a scan radio that performs probe request/response exchanges with the one or more neighboring APs over-the-air.

For example, the system can use a Neighbor Probe Request/Response protocol that is used to request neighbor AP MLDs/APs information through the serving AP. The Neighbor Probe Request/Response protocol defines a Neighbor Probe Request Multi-Link element that identifies from which of the neighbor AP MLDs probe-response information is requested. Further, the Neighbor Probe Request Multi-Link element can include an (Extended) Request element in a Per-STA Profile and can optionally include a list of <BSSID, Requested elements> for pre-802.11be APs. According to certain non-limiting examples, the Neighbor Probe Request Multi-Link element can signal the serving AP to provide requested elements for all 1-hop neighbor AP MLDs/APs. Additionally, the Neighbor Probe Request Multi-Link element can signal for the Neighbor Probe Response to provide requested info for one or more neighbor AP MLDs or APs (e.g., pre-802.11be APs). This improves roaming by providing a single frame exchange to discover roaming-related information for multiple neighboring AP MLDs and/or APs.

According to certain non-limiting examples, neighbor-probe request 512 is sent from STA 502 to serving AP MLD 506. Neighbor-probe request 512 can include a Neighbor Probe Request Multi-link element, such as multi-link element 422 described in FIG. 6. Further, neighbor-probe request 512 can include a Per-STA Profile, such as Per-STA Profile 424 as described in FIG. 6. Additionally or alternatively, neighbor-probe request 512 can include a list of basic service set identifiers (BSSID) and Returned elements, such as BSSID 410 and request elements 436 as described in FIG. 6.

According to certain non-limiting examples, fetch probe-response information 514 includes communications via a wired DS between serving AP MLD 506 and one or more neighboring AP MLDs. These communications allow serving AP MLD 506 to collect the probe-response information that was requested by neighbor-probe request 512. Additionally or alternatively, fetch probe-response information 516 includes communications via the wired DS between serving AP MLD 506 and wireless LAN controllers 510. These communications allow serving AP MLD 506 to collect the probe-response information that was requested by neighbor-probe request 512 without using wireless bandwidth of STA 502.

According to certain non-limiting examples, serving AP MLD 506 filters the information that was collected from the one or more neighboring AP MLDs and/or wireless LAN controller 510 (filter probe-response information 520). For example, the collected information can be filtered based on controls and elements in neighbor-probe request 512 to provide the probe-response information that was requested.

According to certain non-limiting examples, neighbor-probe responses 518 communicates the probe-response information to STA 502. For example, the elements of neighbor-probe response 518 can largely mirror those of neighbor-probe request 512. Neighbor-probe response 518 can include a Neighbor Probe Request Multi-link element similar to multi-link element 422 described in FIG. 6. Further, neighbor-probe response 518 can include a Per-STA Profile, such as Per-STA Profile 424 as described in FIG. 6. Additionally or alternatively, neighbor-probe response 518 can include a list of basic service set identifiers (BSSID) and Returned elements, such as BSSID 410 and request elements 436 as described in FIG. 6.

According to certain non-limiting examples, information from the one or more neighboring AP MLDs and/or wireless LAN controller 510 may have been previously fetched and cached at serving AP MLD 506 before receiving neighbor-probe request 512. When the cached information is sufficiently fresh, the probe-response information in neighbor-probe response 518 can be generated from the cached information, rather than fetching this information again.

FIG. 6 illustrates an example method 600 for using a tunneled query to discover neighboring access points. Although the example method 600 depicts a particular sequence of operations, the sequence may be altered without departing from the scope of the present disclosure. For example, some of the operations depicted may be performed in parallel or in a different sequence that does not materially affect the function of method 600. In other examples, different components of an example device or system that implements method 600 may perform functions at substantially the same time or in a specific sequence.

According to some examples, step 602 of the method includes sending a neighbor-probe request that requests probe-response information, wherein the neighbor probe request is a management frame that includes a multi-link element indicating what information is included in the probe-response information that is requested for one or more neighboring APs of the serving AP. The neighbor probe request instructs the serving AP what information is requested, and the serving AP then determines how to obtain that information from the neighbor AP MLDs and/or APs.

For example, STA 502 illustrated in FIG. 5 may send a neighbor-probe request that requests probe-response information, wherein the neighbor probe request is a management frame that includes a multi-link element indicating what information is included in the probe-response information that is requested for one or more neighboring APs of the serving AP, and the neighbor probe request instructs the serving AP to obtain.

According to some examples, step 604 of the method includes receiving the neighbor-probe request at a serving access point (AP). For example, serving AP MLD 506 illustrated in FIG. 5 may receive the neighbor-probe request from STA 502.

According to some examples, step 606 of the method includes collecting, at the serving AP, the probe-response information using backhaul communications that do not interfere with the wireless communications of the station, wherein the serving AP collects the probe-response information in accordance with the multi-link element.

According to some examples, step 608 of the method includes filtering the probe-response information after collecting the probe-response information for the neighboring AP MLDs, wherein the filtering is performed according to a predefined policy (e.g., the probe-response information is filtered based on the BPCC information received from the station).

For example, serving AP MLD 506 illustrated in FIG. 5 may filter the probe-response information after collecting the probe-response information for the neighboring AP MLDs, wherein the filtering is performed according to a predefined policy (e.g., the probe-response information is filtered based on the BPCC information received from the station).

According to some examples, step 610 of the method includes sending a neighbor-probe response to the station, wherein the neighbor-probe response includes the probe-response information. For example, serving AP MLD 506 illustrated in FIG. 5 may send a neighbor-probe response to the station, wherein the neighbor-probe response includes the probe-response information.

According to some examples, step 612 of the method includes performing roaming based on the neighbor-probe response. For example, STA 502 illustrated in FIG. 5 may perform roaming based on the neighbor-probe response.

According to certain non-limiting examples, the systems and methods disclosed herein define a new element called a neighbor probe request multi-link element, which enables requesting probe response for neighboring APs. The neighbor probe request multi-link element can include an identifier for the target AP ML for which the probe response is requested. This identifier can be an AP MLD MAC address for a target AP, or it can be an AP MLD ID that can be obtained from the reduced neighbor report (RNR), or any other equivalent identifier for the target AP MLD. The identifier can be part of the common info field in the multi-link element so it and then this element can include one or more per star profile sub-element which indicates link IDs for the affiliated APS of that target AP MLD for which information is being requested. When a target AP MLD has three links, for example, then it has three affiliated APs. A station may be interested in the same information for only 5 GHz and 6 GHz links because the station is only planning to associate on one of those two links. Therefore, the station can request information in the probe response only for those two links by providing the link IDs for 5 GHz and 6 GHz in the separate Per-STA Profile sub-element. On the other hand, when no Per-STA Profile sub-element is included, information can be requested for all affiliated APs of the target AP MLD.

According to certain non-limiting examples, the Per-STA Profile sub-element includes a station control field that indicates the last known BSS parameters change count for the neighbor for the neighboring AP MLD and for the specific affiliated AP of that neighboring AP MLD. When the client has acquired the neighbor AP information in the past, the client knows the last status. Accordingly, the BPCC provides the status by indicating the last time the client acquired information for the affiliated AP of the target AP MLD. Thus, the client can signal if nothing has changed, in which case the serving AP does not need to provide that information again. The BPCC can be used as a filtering criterion by the serving AP when providing probe response information to the client.

According to certain non-limiting examples, the station control field includes a complete profile field. The client can set the complete profile field in the multi-link element link element. For example, when the complete profile field is set to one, the client is requesting a complete profile of that affiliated AP. Alternatively, when the complete profile field is set to zero, the client is requesting a partial profile for the affiliated AP. When a partial profile is requested, the station profile field may also include a request element or an extended request element, and, using this request element, the client can request the return for a specific affiliated AP in the probe response. When no request element or external request element is included for a given Per-STA Profile but the overall probe request has requests element and/or extended request element, then the return response corresponding to the given Per-STA Profile is based on the entire probe request, and not from the Per-STA Profile.

That is, for each affiliated A, for which client is requesting information, the client can request a different set of elements based on what information the client is seeking. For example, on the one hand, the client can be seeking information for 2.4 GHz, 5 GHz, or 6 GHz links. On the other hand, when the client is indifferent regarding particular information for each of those links, the client can include these requests element and extended request element in the probe request but outside the Per-STA Profile. In this case, the serving AP returns the requested information for all the links based on the request element that is outside the Per-STA Profile.

According to certain non-limiting examples, the probe request can include a neighbor probe request multi-link element in which the client provides a list of one or more basic service set identifiers (BSSIDs) for neighboring APS (e.g., for the legacy APs). For example, the client may seek to receive a probe response for a specific BSSID. In this case, the client can indicate the specific BSSID by including it in the BSSID element of the neighbor probe request multi-link element. Alternatively, the list of BSSIDs can be part of a new element other than the neighbor probe request multi-link element. When the client does not know the BSSID for the specific target AP MLDs or target APs, the neighbor probe request multi-link element can indicate that the neighbor AP probe response is requested for all neighboring APs. For example, the neighbor probe request multi-link element can indicate that the neighbor AP probe response is requested for all neighboring APs within one hop. Alternatively, the neighbor probe request multi-link element can indicate that the neighbor AP probe response is requested for all neighboring APs within two hops of the serving AP.

According to certain non-limiting examples, an existing probe request is extended to allow the client to include one or more neighbor probe request multi-link elements. Alternatively, this can be an extension to the above-discussed probe request multi-link element. The neighbor probe request multi-link element can indicate neighbor AP MLDs and optionally indicate a subset of affiliated APs, which can be indicated by the link IDs for each AP MLD for which probe responses requested. The neighbor probe request multi-link element can include an SSID element or an SSID list to indicate SSIDs for which neighbor APS information is requested.

According to certain non-limiting examples, existing neighbor report request and response can be extended to provide additional functionality such as obtaining the probe-response information using beacon information to collect the requested information. In this case, the serving AP collects the latest beacon from each of the neighboring APS, and then the neighbor AP discovery request can indicate specific elements to be returned in the beacon. What information from the beacons is requested can be included in a request element or extended request element.

According to certain non-limiting examples, the serving AP MLD collects information for the neighboring AP MLDs requested in the neighbor probe request. This can be achieved in two ways. According to a first example, the serving AP can forward the probe neighbor-probe requests to applicable neighboring APs and/or AP MLDs, and the serving AP can receive probe neighbor-probe response frames from those APs and/or AP MLDs using the wired backhaul distribution system. Additionally or alternatively, in a second example, the serving AP can get the information for the neighboring APs and/or AP MLDs from a neighbor-AP database, which is updated periodically with the latest neighbor AP information. The latest neighbor AP information can include, for example, the latest BSS Load, BPCC, and other dynamic information for neighboring APs and/or AP MLDs.

According to certain non-limiting examples, after collecting the neighboring APs information, the serving AP can filter the probe responses based on BPCC information received from the STA, and based on this filtering the serving AP only sends complete or partial profile for an affiliated AP if BPCC indicates that BSS parameters have changed since last acquired BPCC by the STA for that affiliated AP.

According to certain non-limiting examples, the serving AP can include complete profiles for neighboring APs. A complete profile provides all applicable elements in the probe response. Additionally or alternatively, the serving AP can include a partial profile that provides elements requested in the Request element or Extended Request element included in the neighbor-probe request. According to certain non-limiting examples, the BSS Load element is always included for each reported neighboring AP for which probe response is provided, even when this element was not requested by the STA.

According to certain non-limiting examples, the serving AP MLD can send multiple probe response frames for neighboring APs and/or AP MLDs as part of an aggregated MPDU (A-MPDU), which are either sent to the client or sent as separate probe response frames. The multiple probe response frames can be sent as either multi-link probe responses or non-multi-link probe responses. Alternatively, a new neighbor probe response frame can be used, and the new neighbor probe response frame can be defined to embed frame bodies for multiple probe responses from neighboring APs and/or AP MLDs in a single neighbor probe response frame either per BSSID or per AP MLD identifier. When AP MLD identifiers are used, fragmentation can be used in which the probe response frame body is fragmented across multiple neighbor probe response frames. This fragmentation can be performed using a similar approach as done for beacon-report fragmentation in the baseline 802.11 specification.

According to certain non-limiting examples, when providing probe responses for neighboring APs and/or AP MLDs, the serving AP MLD can determine a filtering policy and apply this filtering policy for 1-hop, 2-hops neighbors. Additionally or alternatively, when providing probe responses for neighboring APs and/or AP MLDs or can apply other policy-based filtering, for example, by providing only neighboring APs information for the APs on the same floor as the STA and or the serving AP. The serving AP MLD can send to the STA probe response frames or the neighbor probe response frame for neighboring APs as protected management frame.

According to certain non-limiting examples, the Neighbor AP Discovery Request frame can be used to indicate whether probe response information is requested for the neighboring APs or beacon information is requested for the neighboring APs. If probe response information is requested, then serving AP collects, filters, and delivers probe responses for neighboring APs as discussed above. According to certain non-limiting examples, the Neighbor Report Request and Response frames defined in 802.11 can be extended to provide the functionality described above for Neighbor AP Discovery Request and Response frames.

When the STA requests beacon information for neighboring APs, the serving AP collects the latest Beacon frame body from each of the requested neighboring APs. The Neighbor AP Discovery Request frame can indicate specific elements to be returned in the beacon by including a Request Element and/or an Extended Request Element indicating list of elements which should be returned in the beacon. The serving AP can apply filtering to limit which elements/information is returned to the STA. For example, by filtering the serving AP can return only those elements in the beacon which were requested in the Request Element and/or an Extended Request Element if those elements are included in the request. When no specific elements were requested using Request Element and/or an Extended Request Element, the serving AP returns all elements in the Beacon frame body for a neighboring AP.

Additionally or alternatively, the serving AP can apply filtering based on BPCC to only provide beacon information for those neighboring APs that indicate an updated BPCC compared to BPCC value received from the client for that neighboring AP. The serving AP can apply its own policy-based filters to further filter beacon information, for example, to provide neighboring APs beacon information for the APs on the same floor only. The Serving AP sends beacon frames for multiple neighboring APs in a Neighbor AP Discovery Response frame with multiple beacon frame body for neighboring APs embedded in the same response frame. Fragmentation of the beacon frame body across multiple response frames can be realized using a similar approach as for Beacon reports fragmentation in the baseline 802.11 specification. According to certain non-limiting examples, the Neighbor AP Discovery Request and Response frames are sent as protected management frames between the client and the serving AP.

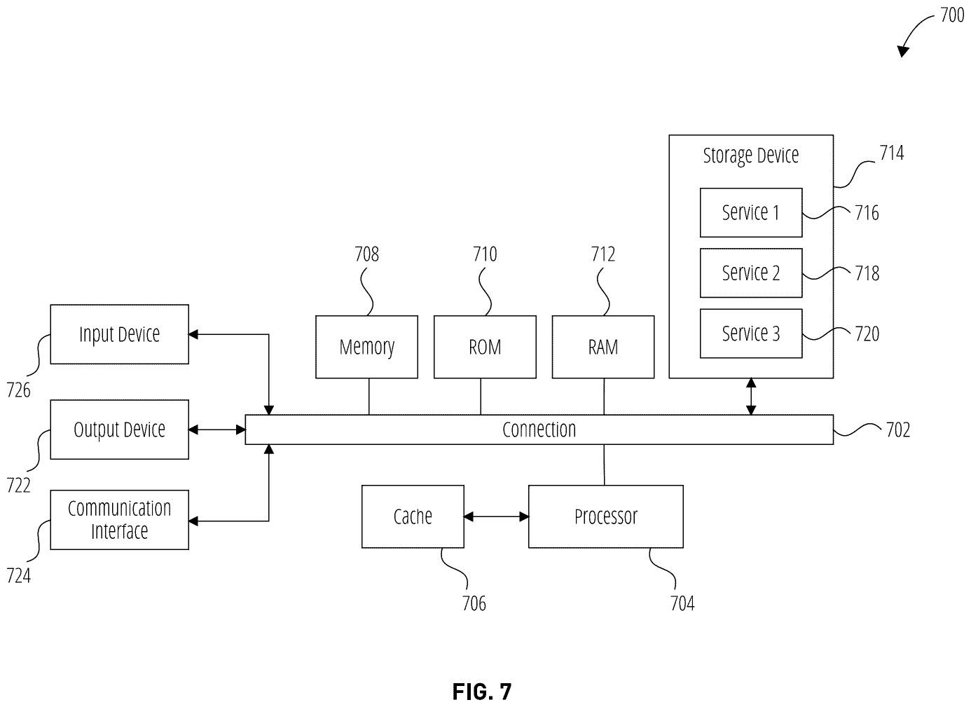

FIG. 7 shows an example of computing system 700, which can be any computing device making up AP actor 102, STA actor 104, wireless LAN controller 110, AP MLDs 212, Non-AP MLDs 214, AP MLD 304, AP MLD 306, AP MLD 308, Non-AP MLD 310, STA 502, serving AP MLD 506, neighbor AP MLDs 508a-c, wireless LAN controller 510, or any component thereof in which the components of the system are in communication with each other using connection 702. Connection 702 can be a physical connection via a bus, or a direct connection into processor 704, such as in a chipset architecture. Connection 702 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 700 includes at least one processing unit (CPU) (e.g., processor 704) and connection 702 that couples various system components including system memory 708, such as read-only memory (e.g., ROM 710) and random access memory (e.g., RAM 712) to processor 704. Computing system 700 can include a cache of high-speed memory 706 connected directly with, in close proximity to, or integrated as part of processor 704.

Processor 704 can include any general-purpose processor and a hardware service or software service, such as services 716, 718, and 720 stored in storage device 714, configured to control processor 704 as well as a special-purpose processor where software instructions are incorporated into the actual processor design. Processor 704 may essentially be a completely self-contained computing system, containing multiple cores or processors, a bus, memory controller, cache, etc. A multi-core processor may be symmetric or asymmetric.

To enable user interaction, computing system 700 includes an input device 726, which can represent any number of input mechanisms, such as a microphone for speech, a touch-sensitive screen for gesture or graphical input, keyboard, mouse, motion input, speech, etc. Computing system 700 can also include output device 722, which can be one or more of a number of output mechanisms known to those of skill in the art. In some instances, multimodal systems can enable a user to provide multiple types of input/output to communicate with computing system 700. Computing system 700 can include communication interface 724, which can generally govern and manage the user input and system output. There is no restriction on operating on any particular hardware arrangement, and therefore the basic features here may easily be substituted for improved hardware or firmware arrangements as they are developed.

Storage device 714 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 714 can include software services, servers, services, etc., that when the code that defines such software is executed by the processor 704, it causes the system to perform a function. In some embodiments, a hardware service that performs a particular function can include the software component stored in a computer-readable medium in connection with the necessary hardware components, such as processor 704, connection 702, output device 722, etc., to carry out the function.

Aspects of the present disclosure can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

IEEE 802.11, commonly referred to as Wi-Fi, has been around for three decades and has become arguably one of the most popular wireless communication standards, with billions of devices supporting more than half of the worldwide wireless traffic. The increasing user demands in terms of throughput, capacity, latency, spectrum and power efficiency calls for updates or amendments to the standard to keep up with them. As such, Wi-Fi generally has a new amendment after every 5 years with its own characteristic features. In the earlier generations, the focus was primarily higher data rates, but with ever increasing density of devices, area efficiency has become a major concern for Wi-Fi networks. Due to this issue, the last (802.11 be (Wi-Fi 7)) amendments focused more on efficiency. The next expected update to IEEE 802.11 is coined as Wi-Fi 8. Wi-Fi 8 will attempt to further enhance throughput and to minimize latency to meet the ever-growing demand for the Internet of Things (IoT), high resolution video streaming, low-latency wireless services, etc.

Multiple Access Point (AP) coordination and transmission in Wi-Fi refers to the management of multiple access points in a wireless network to avoid interference and ensure efficient communication between the client devices and the network. When multiple access points are deployed in a network—for instance in buildings and office complexes—they operate on the same radio frequency, which can cause interference and degrade the network performance. To mitigate this issue, access points can be configured to coordinate their transmissions and avoid overlapping channels.

Wi-Fi 7 introduced the concept of multi-link operation (MLO), which gives the devices (Access Points (APs) and Stations (STAs)) the capability to operate on multiple links (or even bands) at the same time. MLO introduces a new paradigm to multi-AP coordination which was not part of the earlier coordination approaches. MLO is considered in Wi-Fi-7 to improve the throughput of the network and address the latency issues by allowing devices to use multiple links.

A multi-link device (MLD) may have several “affiliated” devices, each affiliated device having a separate PHY interface, and the MLD having a single link to the Logical Link Control (LLC) layer. In the proposed IEEE 802.11be draft, a multi-link device (MLD) is defined as: “A device that is a logical entity and has more than one affiliated station (STA) and has a single medium access control (MAC) service access point (SAP) to logical link control (LLC), which includes one MAC data service” (see: LAN/MAN Standards Committee of the IEEE Computer Society, Amendment 8: Enhancements for extremely high throughput (EHT), IEEE P802.11 be™/D0.1, September 2020, section 3.2). Connection(s) with an MLD on the affiliated devices may occur independently or jointly. A preliminary definition and scope of a multi-link element is described in section 9.4.2.247b of aforementioned IEEE 802.11 be draft. An idea behind this information element/container is to provide a way for multi-link devices (MLDs) to share the capabilities of different links with each other and facilitate the discovery and association processes. However, this information element may still be changed or new mechanisms may be introduced to share the MLO information (e.g. related to backhaul usage).

In multi-link operation (MLO) both STA and APs can possess multiple links that can be simultaneously active. These links may or may not use the same bands/channels.

MLO allows sending PHY protocol data units (PPDUs) on more than one link between a STA and an AP. The links may be carried on different channels, which may be in different frequency bands. Based on the frequency band and/or channel separation and filter performance, there may be restrictions on the way the PPDUs are sent on each of the links.

MLO may include a basic transmission mode, an asynchronous transmission mode, and a synchronous transmission mode.

In a basic transmission mode, there may be multiple primary links, but a device may transmit PPDU on one link at a time. The link for transmission may be selected as follows. The device (such as an AP or a STA) may count down a random back off (RBO) on both links and select a link that wins the medium for transmission. The other link may be blocked by in-device interference. In basic transmission mode, aggregation gains may not be achieved.

In an asynchronous transmission mode, a device may count down the RBO on both links and perform PPDU transmission independently on each link. The asynchronous transmission mode may be used when the device can support simultaneous transmission and reception with bands that have sufficient frequency separation such as separation between the 2.4 GHz band and the 5 GHz band. The asynchronous transmission mode may provide both latency and aggregation gains.

In a synchronous PPDU transmission mode, the device may count down the RBO on both links. If a first link wins the medium, both links may transmit PPDUs at the same time. The transmission at the same time may minimize in-device interference and may provide both latency and aggregation gains.

Multi-AP coordination and MLO are two features proposed to improve the performance of Wi-Fi networks in the upcoming IEEE 802.11 be amendment. Multi-AP coordination is directed toward utilizing (distributed) coordination between different APs to reduce inter-Basic Service Set (BSS) interference for improved spectrum utilization in dense deployments. MLO, on the other hand, supports high data rates and low latency by leveraging flexible resource utilization offered by the use of multiple links for the same device.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method for discovering neighboring candidate access points, the method comprising:
receiving, at a serving AP (access point), a neighbor-probe request from a station requesting probe-response information, wherein the neighbor-probe request is a management frame that includes one or more multi-link elements indicating what information is to be included in the probe-response information that is requested for one or more neighboring APs or AP MLDs (multi-link devices) of the serving AP;
collecting, at the serving AP, the probe-response information for the one or more neighboring APs of the serving AP, wherein the serving AP collects the probe-response information in accordance with the one or more multi-link elements; and
sending, from the serving AP to the station, a neighbor-probe response that includes the probe-response information.

2. The method of claim 1, wherein:
the station is a non-AP MLD,
the serving AP is an AP MLD, and
the one or more neighboring APs includes at least one AP MLD that is a neighboring AP MLD of the serving AP.

3. The method of claim 1, wherein:
at least one of the one or more neighboring APs is an AP multi-link device (MLD),
the neighbor-probe request includes the one or more multi-link elements,
the one or more multi-link elements includes one or more identifiers for one or more target AP MLDs for which the probe-response information is requested, and
each multi-link element of the one or more multi-link elements is a neighbor probe request multi-link element.

4. The method of claim 3, wherein:
the neighbor probe request multi-link element is a multi-link element with a new type, or a probe request multi-link element,
the one or more identifiers are MLD media access control (MAC) Address, AP MLD identifiers (IDs), or another identifier for a target AP MLD, and
the neighbor-probe request is a probe request frame or another management frame and the neighbor-probe response is a probe response frame or another management frame.

5. The method of claim 3, wherein:
each of the one or more multi-link elements includes one or more sub-elements indicating link IDs of a subset of affiliated APs of a target AP MLD,
and the link IDs in the one or more sub-elements indicate that the probe-response information is requested for the subset of affiliated APs indicated by the Link IDs,
the one or more sub-elements are one or more Per-STA Profile sub-elements, and
an absence of the one or more sub-elements indicates that the probe-response information is requested for all affiliated APs of the target AP MLD.

6. The method of claim 5, wherein:
each sub-element in the one or more sub-elements includes a station control field indicating a value of a last known basic service set (BSS) parameters change count (BPCC) for respective affiliated AP of the target AP MLD indicated by the link IDs,
the station control field includes a complete profile subfield that signals whether a complete profile or a partial profile is requested for an affiliated AP of the target AP MLD, and
when a value signaled by the complete profile subfield indicates that the partial profile of the affiliated AP is requested, values of a station profile field include one or more request elements and/or one or more extended request element that indicate specific elements for which affiliated AP information is requested for the affiliated AP, and
an absence of the one or more request elements and/or an absence of the one or more extended request elements signals indicating that the one or more neighboring APs for which elements are returned are determined by other elements included in the neighbor-probe request.

7. The method of claim 1, wherein the neighbor-probe request includes a basic service set identifier (BSSID) element indicating a list of BSSIDs (basic service set identifiers) of the one or more neighboring APs for which the probe-response information is requested.

8. The method of claim 1, wherein:
the neighbor-probe request includes an SSID (service set identifier) element that indicates one or more SSIDs of neighboring APs or AP MLDs for which the probe-response information is requested, and
an absence of SSID information in the SSID element signals the receiving AP to use all SSIDs for providing probe responses for the one or more neighboring APs or AP MLDs.

9. The method of claim 1, wherein:
collecting the probe-response information that is requested in the neighbor-probe request includes sending, by the serving AP and over a wired distribution system network, information of the neighbor-probe request to selected neighboring APs and/or AP MLDs, and
collecting the probe-response information further includes receiving, in response to sending the information of the neighbor-probe request, probe-response frames from the selected neighboring APs and/or AP MLDs.

10. The method of claim 1, wherein:
collecting the probe-response information that is requested in the neighbor-probe request includes retrieving, by the serving AP and over a wired distribution system network, the probe-response information from a neighbor AP database,
the neighbor AP database is updated periodically with latest neighbor AP information, and
the latest neighbor AP information comprises a latest basic service set (BSS) load, a BPCC, and/or other static and dynamic information for the one or more neighboring APs.

11. The method of claim 1, further comprising:
filtering, at the serving AP, the probe-response information after the serving AP collects the probe-response information for the one or more neighboring APs, wherein
filtering the probe-response information is based on BPCC information received from the station, and
sending the neighbor-probe response includes sending profile information for an affiliated AP when the BPCC information indicates that BSS parameters have changed since a last acquired BPCC by the station for that affiliated AP.

12. The method of claim 1, further comprising:
filtering, at the serving AP, the probe-response information according to a predefined policy after the serving AP collects the probe-response information for the one or more neighboring APs, wherein
the predefined policy limits the probe-response information to APs on a same floor as the serving AP.

13. The method of claim 1, further comprising:
sending, in response to the neighbor-probe request and as part of the neighbor-probe response from the serving AP to the station, a complete profile for a neighboring AP or a partial profile for a neighboring AP providing only elements that are requested in one or more request elements or in one or more extended request element in the neighbor-probe request.

14. The method of claim 1, further comprising:
sending, as part of the neighbor-probe response from the serving AP, multiple probe response frames for the one or more neighboring APs as part of an aggregated MAC protocol data unit (A-MPDU) that is sent to the station;
sending, as part of the neighbor-probe response from the serving AP, the multiple probe response frames for the one or more neighboring APs or neighboring AP MLDs as part of separate probe response frames that are sent to the station; or
sending, as part of the neighbor-probe response from the serving AP, a neighbor-probe-response frame that is configured to embed frame bodies for multiple probe responses from the one or more neighboring APs or neighboring AP MLDs in a single neighbor probe response frame.

15. The method of claim 1, wherein:
the neighbor-probe request includes indicia whether the probe-response information is requested for the one or more neighboring APs or beacon information is requested for the one or more neighboring APs, and
when the neighbor-probe request includes a request for the beacon information for the one or more neighboring APs, the serving AP collects a beacon frame body from each of the one or more neighboring APs for which the beacon information is requested.

16. The method of claim 15, wherein:
the neighbor-probe request includes a request element or extended request element that provides a list of elements indicating which elements to be returned in respective beacons,
when one or more request elements or extended request elements, are included in the neighbor-probe request from the station, the serving AP filters the information from the respective beacons to restrict information returned in a beacon included in the neighbor-probe response to information in the beacon that corresponds to the one or more request elements or extended request element, and
when the request element or extended request element is absent from the neighbor-probe request, the serving AP returns all elements in the beacon frame body for a neighboring AP.

17. The method of claim 16, wherein:
the neighbor-probe request includes BPCC values for one or more affiliated APs of neighboring AP MLDs,
when the BPCC values are included for the one or more affiliated APs of neighboring AP MLDs in the neighbor-probe request, the serving AP returns the beacon information in the neighbor-probe response only for those affiliated APs for which the BPCC information indicates that BSS parameters have changed since a last acquired BPCC by the station for that affiliated AP.

18. A computing apparatus comprising:
a processor; and
a memory storing instructions that, when executed by the processor, configure the computing apparatus to:
receive, at a serving AP (access point), a neighbor-probe request from a station requesting probe-response information, wherein the neighbor-probe request is a management frame that includes one or more multi-link elements indicating what information is to be included in the probe-response information that is requested for one or more neighboring APs of the serving AP;
collect, at the serving AP, the probe-response information for the one or more neighboring APs of the serving AP, wherein the serving AP collects the probe-response information in accordance with the one or more multi-link elements; and
send, from the serving AP to the station, a neighbor-probe response that includes the probe-response information.

19. The computing apparatus of claim 18, wherein:
at least one of the one or more neighboring APs is an AP multi-link device (MLD),
the neighbor-probe request includes the one or more multi-link elements,
the one or more multi-link elements include one or more identifiers for one or more target AP MLDs for which the probe-response information is requested, and
each multi-link element of the one or more multi-link elements is a neighbor probe request multi-link element.

20. A non-transitory computer-readable storage medium, the non-transitory computer-readable storage medium including instructions that when executed by a computer, cause the computer to:
receive, at a serving AP (access point), a neighbor-probe request from a station requesting probe-response information, wherein the neighbor-probe request is a management frame that includes one or more multi-link elements indicating what information is to be included in the probe-response information that is requested for one or more neighboring APs of the serving AP;
collect, at the serving AP, the probe-response information for the one or more neighboring APs of the serving AP, wherein the serving AP collects the probe-response information in accordance with the one or more multi-link elements; and
send, from the serving AP to the station, a neighbor-probe response that includes the probe-response information.
